(19) United States
(12) Patent Application Publication
(10) Pub. No.: US 2020/0275149 A1
(43) Pub. Date: Aug. 27, 2020

(54) MULTI-SCREEN SYNCHRONIZED PLAYBACK SYSTEM AND METHOD THEREOF

(71) Applicant: Novatek Microelectronics Corp., Hsinchu (TW)

(72) Inventors: Yung-Chih Su, Hsinchu City (TW); Hong-Ruei Jhang, Hsinchu County (TW)

(73) Assignee: Novatek Microelectronics Corp., Hsinchu (TW)

(21) Appl. No.: 16/286,630

(22) Filed: Feb. 27, 2019

(51) Int. Cl. H04N 21/43; H04N 21/643; H04N 21/61

(52) U.S. Cl. CPC H04N 21/4302; H04N 21/61; H04N 21/643

(57) ABSTRACT

A multi-screen synchronized playback system including a group, a network time protocol (NTP) server is provided. The group includes a plurality of playback devices connected to a local area network (LAN). One of the playback devices is designated as a master playback device, the remaining playback devices of the playback devices are designated as slave playback devices. The NTP server is connected to the LAN and provides a standard time information for each of the playback devices. In preparing state, the master playback device sends a first type packet to each of the slave playback devices through the local area network, and the first type packet includes a starting playback time information according to the standard time information provided by the NTP server. A multi-screen synchronized playback method is also provided.

### BACKGROUND

### Technical Field

The disclosure relates to a multi-screen synchronized playback system capable of achieving accurate playback synchronization without any additional hardware device required and a method thereof.

### Description of Related Art

In the conventional art, a plurality of screens are used to display the same picture/image/frame, or to display different sections/parts of the same picture/image/frame while playing a video. In order to avoid error while the different screens display the image at the same time, an additional hardware device, such as graphic card, is needed to connect each of the screens in series. Because of those special hardware devices, the media stream is synchronously broadcasted/displayed on, for example, a large screen used for concerts or outdoor advertising. However, by using additional hardware devices so that a group of a plurality screens can display different sections/parts of one frame of the video, one additional hardware device is required for each of the screens. Therefore, the cost is considerable.

### SUMMARY

The disclosure is directed to a multi-screen synchronized playback system capable of achieving accurate playback synchronization without any additional hardware device required and a method thereof.

A multi-screen synchronized playback system of the disclosure includes a group and a network time protocol (NTP) server. The group includes a plurality of playback devices connected to a local area network (LAN). One of the playback devices is designated as a master playback device, the remaining playback devices of the plurality of playback devices are designated as slave playback devices. The NTP server is connected to the LAN and provides a standard time information for each of the playback devices. In preparing state, the master playback device sends a first type packet to each of the slave playback devices through the LAN, and the first type packet includes a starting playback time information according to the standard time information provided by the NTP server.

In one embodiment of the disclosure, the slave playback devices receive the first type packet from the master playback device in preparing state, and playback processes of the slave playback devices and a playback process of the master playback device are synchronously started based on the starting playback time information.

In one embodiment of the disclosure, in playback state, the master playback device sends a second type packet to each of the slave playback devices through the local area network, and the second type packet includes a playback timepoint of the master playback device.

In one embodiment of the disclosure, the time difference between the playback timepoint of each of the slave playback devices and the playback timepoint of the master playback device is kept within a preset time.

In one embodiment of the disclosure, an election mechanism is used to elect a new master playback device based on a device identity of each of the slave playback devices when the slave playback devices do not receive the second type packet.

In one embodiment of the disclosure, each of the first type packet and the second type packet is a string datatype comprising a packet type, a group identity, a device identity, and a data.

A multi-screen synchronized playback method of a multi-screen synchronized playback system having a group including a plurality of playback devices connected to a local area network (LAN) and a network time protocol (NTP) server connected to the LAN of the disclosure includes the following steps: appointing one of the plurality of playback devices as a master playback device; appointing the remaining playback devices of the plurality of playback devices as slave playback devices; providing a standard time information, by the NTP server, for each of the plurality of playback devices; sending a first type packet, by the master playback device, to each of the slave playback devices in preparing state through the local area network, wherein the first type packet includes a starting playback time information according to the standard time information provided by the NTP server; and starting playback processes of the slave playback devices and a playback process of the master playback device synchronously based on the starting playback time information after the slave playback devices receive the first type packet from the master playback device in preparing state.

In one embodiment of the disclosure, the multi-screen synchronized playback method further includes the step of sending a second type packet, by the master playback device, to each of the slave playback devices in playback state through the local area network. The second type packet includes a playback timepoint of the master playback device.

In one embodiment of the disclosure, the multi-screen synchronized playback method further includes the step of adjusting a time difference between the playback timepoint of each of the slave playback devices and the playback timepoint of the master playback device to be within a preset time.

In one embodiment of the disclosure, the multi-screen synchronized playback method further includes the step of electing a new master playback device based on a device identity of each of the slave playback devices when the slave playback devices do not receive the second type packet.

The disclosure provides a master playback process of a master playback device in a multi-screen synchronized playback system. The multi-screen synchronized playback system has a group including the master playback device and a plurality of slave playback devices, the master playback device and the slave playback devices are connected to a local area network (LAN), and a network time protocol (NTP) server is connected to the LAN. The master playback process of the master playback device in the multi-screen synchronized playback system includes steps of entering a preparing state; broadcasting a first type packet to the slave playback devices in the preparing state, wherein the first type packet comprises a starting playback time information according to a standard time information provided by the NTP server; entering a playback state based on the starting playback time information to perform a playback process; broadcasting a second type packet to the slave playback devices while performing the playback process in the playback state, wherein the second type packet comprises a playback timepoint of the master playback device; and returning to the preparing state after the playback process ends.

In one embodiment of the disclosure, the master playback process of the master playback device in the multi-screen synchronized playback system further includes steps of entering a reset state when receiving the first type packet in the preparing state or when receiving the second type packet in the playback state; broadcasting a third type packet; and switching to be a slave playback device when receiving the third type packet from another playback device having a smaller device identity than the master playback device.

In one embodiment of the disclosure, the master playback process of the master playback device in the multi-screen synchronized playback system further includes steps of staying as the master playback device and returning to the preparing state or the playback state when not receiving the third type packet from another playback device having a smaller device identity than the master playback device.

In one embodiment of the disclosure, the master playback process of the master playback device in the multi-screen synchronized playback system further includes steps of starting a configuration process after being designated as the master playback device.

The disclosure provides a slave playback process of a slave playback device in a multi-screen synchronized playback system. The multi-screen synchronized playback system has a group comprising a master playback device and a plurality of the slave playback devices, the master playback device and the slave playback devices are connected to a local area network (LAN), and a network time protocol (NTP) server is connected to the LAN. The slave playback process of the slave playback device in the multi-screen synchronized playback system includes steps of entering a preparing state; receiving a first type packet from the master playback device in the preparing state, wherein the first type packet comprises a starting playback time information according to a standard time information provided by the NTP server; entering a playback state based on the starting playback time information to perform a playback process; receiving a second type packet from the master playback device while performing the playback process in the playback state, wherein the second type packet comprises a playback timepoint of the master playback device; adjusting a time difference between a playback timepoint of the slave playback device and the playback timepoint of the master playback device to be within a preset time while performing the playback process in the playback state; and returning to the preparing state after the playback process ends.

In one embodiment of the disclosure, the slave playback process of the slave playback device in the multi-screen synchronized playback system further includes steps of entering a reset state when receiving a third type packet; and returning to the preparing state or the playback state when receiving a fourth type packet, wherein the fourth type packet comprises identity information of a current master playback device.

In one embodiment of the disclosure, the slave playback process of the slave playback device in the multi-screen synchronized playback system further includes steps of entering an Is Master Alive state when, in a first period of time, not receiving the first type packet in the preparing state or when, in a first period of time, not receiving the second type packet in the playback state; broadcasting a fifth type packet in the Is Master Alive state; and returning to the preparing state when receiving the first type packet or returning to the playback state when receiving the second type packet.

In one embodiment of the disclosure, the slave playback process of the slave playback device in the multi-screen synchronized playback system further includes steps of entering a disconnect state from the Is Master Alive state when not receiving the first type packet and not receiving the second type packet in a second period of time.

In one embodiment of the disclosure, the slave playback process of the slave playback device in the multi-screen synchronized playback system further includes steps of returning to the preparing state from the disconnect state when receiving the first type packet or returning to the playback state from the disconnect state when receiving the second type packet.

In one embodiment of the disclosure, the slave playback process of the slave playback device in the multi-screen synchronized playback system further includes steps of switching to be a master playback device when, in a second period of time and in the Is Master Alive state, not receiving the fifth type packet from another playback device having a smaller device identity than the slave playback device.

In one embodiment of the disclosure, the slave playback process of the slave playback device in the multi-screen synchronized playback system further includes steps of starting a configuration process after being designated as the slave playback device.

Based on the above, in the disclosure, the playback devices in the same group can achieve the function of automatically controlling the playback progress via network protocol, in order to achieve synchronous playback without any additional hardware device required. The playback devices indicated as in the same group join the same LAN via Ethernet or Wireless Network. By assigning weight method, the user can appoint one of the playback devices in one group as master playback device, and the other playback devices in the same group are designated as slave playback devices. The master playback device and the slave playback devices obtain an accurate time for synchronization through network and designated/specified NTP server. The master playback device, viva a specific/designated network protocol, sends the time information, such as starting playback time information and playback timepoint, for playback in order to control the playback process of the slave playback devices, thereby achieving playback synchronization.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a multi-screen synchronized playback system according to an embodiment of the disclosure.

FIG. 2 is a schematic view showing format of a packet in the network protocol.

FIG. 3 is a schematic view indicating states of the master playback device shown in FIG. 1.

FIG. 4 is a schematic view indicating states of the slave playback device shown in FIG. 1.

FIG. 5A is a schematic view illustrating difference in playback timepoint between a master playback device and a slave playback device shown in FIG. 1.

FIG. 5B is a schematic view of adjustment in playback timepoint of the slave playback device in FIG. 5A.

FIG. 6A is a schematic view illustrating difference in playback timepoint between a master playback device and a slave playback device shown in FIG. 1.

FIG. 6B is a schematic view of adjustment in playback timepoint of the slave playback device in FIG. 6A.

FIG. 7 is a flowchart showing a multi-screen synchronized playback method of a group shown in FIG. 1.

FIG. 8 is a flow chart depicting a master playback process of the master playback device in FIG. 3.

FIG. 9 is a flowchart depicting a slave playback process of the slave playback device in FIG. 4.

FIG. 10 is a flowchart depicting the slave playback process of the slave playback device in FIG. 4.

FIG. 11 is a flowchart depicting the slave playback process of the slave playback device in FIG. 4.

### DESCRIPTION OF THE EMBODIMENTS

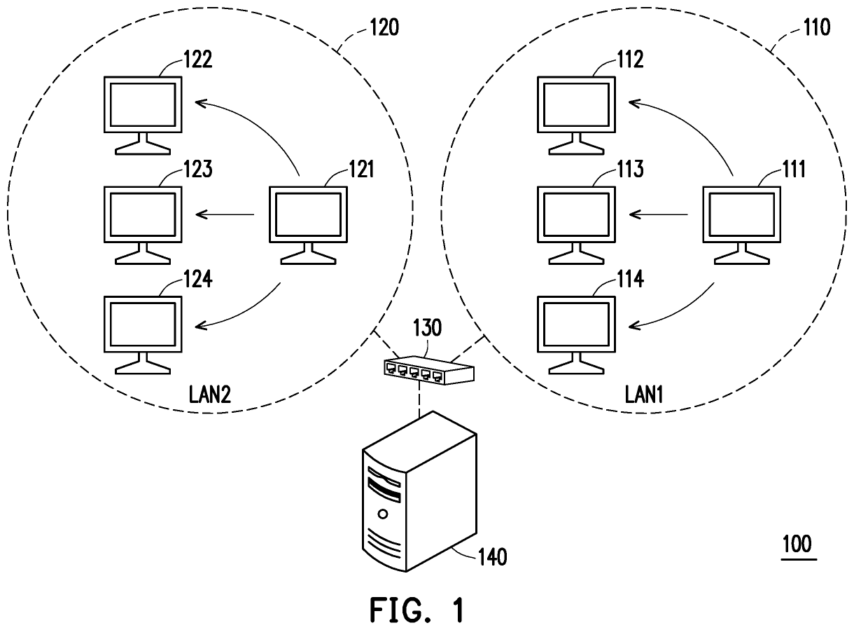

FIG. 1 is a schematic view of a multi-screen synchronized playback system according to an embodiment of the disclosure. To be more specific, a multi-screen synchronized playback system 100 shown in FIG. 1 includes a first group 110, a second group 120, a network hub 130, and a network time protocol (NTP) server 140. There are two groups 110 and 120 illustrated in FIG. 1 as an example, but the disclosure is not limited thereto. In other embodiments, there may be one group or more than two groups. Further, in the present embodiment, the first group 110 includes four playback devices 111, 112, 113, and 114 connected to the first local area network LAN1. The second group 120 includes four playback devices 121, 122, 123, and 124 connected to the second local area network LAN2. The four playback devices 111, 112, 113, and 114 join the first local area network LAN1 via Ethernet or Wireless Network. Similarly, the four playback devices 121, 122, 123, and 124 join the second local area network LAN2 via Ethernet or Wireless Network. Each of the first local area network LAN1 and the second local area network LAN2 is connected to the network hub 130, and the network hub 130 is connected to the NTP server 140. The working principle of the second group 120 is similar to the first group 110, and, the working principle of the first group 110 is mainly described hereinafter.

In the present embodiment, a weight is assigned to each of the playback devices 111, 112, 113, and 114 in the first group 110. Based on the weights, in the first group 110, one of the playback devices 111, 112, 113, and 114 is designated as a master playback device, and the remaining playback devices of the playback devices 111, 112, 113, and 114 are designated as slave playback devices. To be more specific, as shown in FIG. 1, the playback device 111 is designated as the master playback device, and the playback devices 112, 113, and 114 are designated as slave playback devices. In the same way, by assigning a weight to each of the playback devices 121, 122, 123, and 124 in the second group 120, the playback device 121 is designated as the master playback device, and the playback devices 122, 123, and 124 are designated as slave playback devices. In the present embodiment, the user assigns weights to the playback devices in each group in order to select the master playback device and the slave playback devices in each group. In other words, the user appoints one of the playback devices in each group as the master playback device and appoints the rest of the playback devices in each group as the slave playback devices by weight assigning method, the disclosure is not limited thereto.

In the present embodiment, the NTP server 140 is connected to the first local area network LAN1 and the second local area network LAN2. The NTP server 140 provides a standard time information for each of the playback devices 111, 112, 113, and 114 in the first group 110 and for each of playback devices 121, 122, 123, and 124 in the second group 120. Therefore, the standard time information from the NTP server 140 can serve as a benchmark that the playback devices 111, 112, 113, and 114 in the first group 110 can perform the display function or playback process according to and that the playback devices 121, 122, 123, and 124 in the second group 120 can perform the display function or playback process according to. That is to say, in the first group 110, the master playback device 111 and the slave playback devices 112, 113, and 114 receive the same standard time information from the NTP server 140 and thus display video according to the standard time information in order to achieve accurate synchronization. Specifically, the master playback device 111, via a specific network protocol, sends the time information for playback to each of the slave playback devices 112, 113, and 114, in order to control the playback process of the slave playback devices 112, 113, and 114, thereby achieving playback synchronization in the first group 110. That is, in preparing state when the playback devices 111 to 114 are waiting to perform playback process, the master playback device 111 sends the first type packet to each of the slave playback devices 112 to 114 through the first local area network LAN1, and the first type packet includes a starting playback time information according to the standard time information provided by the NTP server 140. It should be noted here, the starting playback time information may be the time for the playback devices 111-114 to synchronously start the playback processes, and the disclosure is not limited thereto. The slave playback devices 112 to 114 receive the first type packet from the master playback device 111 in preparing state, and the playback processes of the slave playback devices 112 to 114 and the playback process of the master playback device 111 are synchronously started based on the starting playback time information. In other words, the master playback device 111 and the slave playback devices 112 to 114 together display a video file synchronously.

Further, in playback state when the playback devices 111 to 114 together display the video file, the master playback device 111 sends the second type packet to each of the slave playback devices 112 to 114 through the first local area network LAN1, and the second type packet include the playback timepoint of the master playback device 111. Similarly, in the same way, the playback synchronization in the second group 120 is also achieved. The details will be described hereinafter.

It should be noted here, in the present embodiment, the user sets the properties of each of the playback devices 111, 112, 113, and 114 in the first group 110 and each of the playback devices 121, 122, 123, and 124 in the second group 120. The properties include the weight of the playback device, the group identity (group ID, such as the first group 110 or the second group 120), device identity (device ID), the playback mode, the predetermined playback time, the video file to be played, and the WIFI Access Point to be connected, etc. The playback device with the weight set to 1 becomes the master playback device of the group, and the rest of the playback devices in the same group are the slave playback devices. For example, in the first group 110 of the present embodiment, the weight of the playback device 111 is set to 1 so that the playback device 111 is designated as the master playback device. Consequently, the weights of the playback devices 112, 113, and 114 are set to 2, 3, and 4, respectively, and are designated as slave playback devices. Similarly, the second group 120, the weight of the playback device 121 is set to 1 and the weights of the playback devices 122, 123, and 124 are set to be greater than 1.

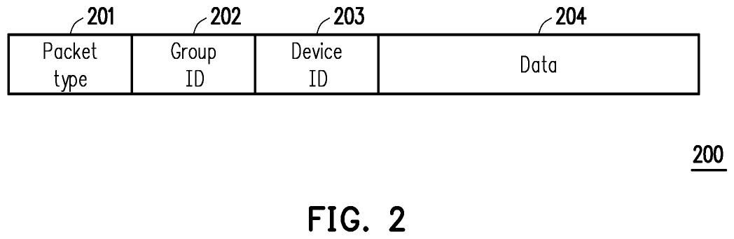

In each of the group, the master playback device controls the playback process of the slave playback devices through the specific network protocol so that playback processes of the master playback device and the slave playback devices can be accurately synchronized. FIG. 2 is a schematic view showing format of a packet in the network protocol. As show in FIG. 2, a packet 200 has content constituted by a string datatype including a packet type 201, a group ID 202, a device ID 203, and a data 204. To be more specific, the packet type 201 is used to indicate the function of the packet 200. The group ID 202 is used to determine the group that the packet 200 is addressed to and processed by. The device ID 203 represents the playback device that sends the packet 200. The data 204 is used to contain actual data content.

There are instructions constituted by five types of the packet 200 in the specific network protocol. The five types of the packet 200 are “SynStartPlayTime” packet, “SyncPlayTime” packet, “WhoIsMaster” packet, “Reset” packet, and “MasterIsAfterReset” packet. Each of the five types of the packet 200 is described hereinafter.

The “SynStartPlayTime” packet is issued by the master playback device. After each playback ends, the playback devices enter a preparing state (or preparing period) to prepare for the next playback. At this point, the master playback device sends a “SynStartPlayTime” packet every second to inform the slave playback devices in the same group about the time when the next playback is scheduled. The “SynStartPlayTime” packet is the first type packet mentioned above.

The “SyncPlayTime” packet is issued by the master playback device. During the playback process of the video, the master playback device sends a “SyncPlayTime” packet every second to inform the Slave playback devices in the same group about the playback timepoint of the video is currently played in the master playback device, so as to synchronize the playback progresses in all the Slave playback devices in the same group with the playback process in the master playback device. The “SyncPlayTime” packet is the second type packet.

The “Reset” packet is issued when there are more than one master playback device existing in the playback devices of the same group. In this case, the master playback device sends the “Reset” packet to notify all playback devices in the same group to enter the reset state and to wait for an election mechanism to select a unique master playback device. The election mechanism will be further described hereinafter. The “Reset” packet is the third type packet.

The “MasterIsAfterReset” packet is issued after the election is over. At that time, one of the playback devices in the same group is selected/designated to be the master playback device, and the newly selected master playback device issues the “MasterIsAfterReset” packet to inform the playback devices in the same group about the identity of the playback device that is the current master playback device, and the Reset state is switched back to the preparing state or the playback state in which the playback is occurring. The “MasterIsAfterReset” packet is the fourth type packet.

The “WhoIsMaster” packet is issued by the Slave playback devices. In case that, the slave playback devices do not receive the “SynStartPlayTime” packet from the master playback device while preparing for the playback process, or in case that the slave playback devices do not receive the “SyncPlayTime” packet from the master playback device while the video is played in the playback process, the slave playback devices will issue a “WhoIsMaster” packet to inquire whether the master playback device is disconnected from the network. The “WhoIsMaster” packet is the fifth type packet.

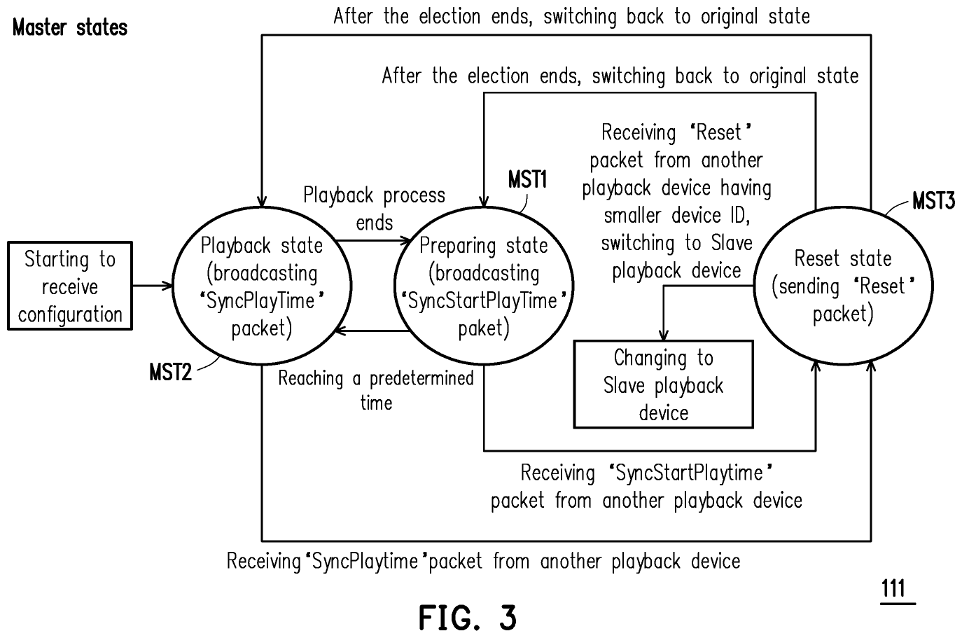

FIG. 3 is a schematic view indicating states of the master playback device shown in FIG. 1. To be more specific, the states of the master playback device 111 in the first group 110 are described in FIG. 3. The states of other master playback devices (such as the master playback device 121) in other groups are similar to the states of the master playback device 111. In the present embodiment, after the playback device 111 in the first group 110 is designated as the master playback device, the master playback device starts to receive configuration or, in other words, starts configuration process. At this time, it is confirmed that the setting file is obtained in the storage medium of the USB interface. In addition, when the predetermined time in the setting file is reached, the playback starts and the master playback device 111 enters a playback state MST2. In the playback state MST2, the master playback device 111 plays the video. In addition, the master playback device 111 broadcasts the “SyncPlayTime” packet to the slave playback devices 112, 113, and 114. In other words, the master playback device 111 sends “SyncPlayTime” packet every second to each of the slave playback devices 112, 113, and 114, so as to inform each of the slave playback devices 112, 113, and 114 in the group 110 about the playback timepoint of the video is currently played in the master playback device 111. Since the playback timepoint of the video played in the master playback device 111 and the standard time information are all received by the slave playback devices 112, 113, and 114, the playback process of the master playback device 111 and the playback processes of the slave playback devices 112, 113, and 114 are synchronized with each other in the first group 110. To be more specific, in the present embodiment, the master playback device 111 plays one part of the frame of the video, and the slave playback devices 112, 113, and 114 play the other parts of the same video at the same time. Therefore, the master playback device 111 and the slave playback devices 112, 113, and 114 together display and form one image or one frame of the video at a timepoint, thereby achieving playback synchronization in the first group 110.

Next, after the playback process of one video ends and the playback process of the next video is not required, the master playback device 111 enters/returns to a preparing state MST1. In the preparing state MST1, the master playback device 111 broadcasts the “SynStartPlayTime” packet every second to inform each of the slave playback devices 112, 113, and 114 in the group 110 about the predetermined time when the next playback process is scheduled. To be more specific, the predetermined time when the next playback process is scheduled is the starting playback time information according to the standard time information provided by the NTP server 140. When the predetermined time is reached, the master playback device 111 enters the playback state MST2 again, and the master playback device 111 and the slave playback devices 112, 113, and 114 display respective parts of a figure/a frame of the next video at the same time, achieving playback synchronization in the first group 110.

However, there is a situation that the master playback device 111 is disconnected from the first local area network LAN1 and one of the slave playback devices 112, 113, and 114 is selected to be the current master playback device in order to replace the master playback device 111. When the playback device 111 is connected to the first local area network LAN1 again, there are some cases as follows. In case that the playback device 111 is connected to the first local area network LAN1 again in the preparing state MST1 and receives the “SynStartPlayTime” packet sent by another playback device (such as one of the slave playback devices 112, 113, and 114) in the first group 110, or in case that the playback device 111 is connected to the first local area network LAN1 again in the playback state MST2 and receives the “SyncPlayTime” packet sent by another playback device (such as one of the slave playback devices 112, 113, and 114) in the first group 110, the playback device 111 will enter a reset state MST3 and will broadcast the “Reset” packet, so as to send the “Reset” packet to each of the slave playback devices 112, 113, and 114 in the first group 110. At this time, the current master playback device, which is one of the one of the playback devices 112, 113, and 114, will also broadcast the “Reset” packet, so as to send the “Reset” packet to the playback device 111. If the playback device 111 receives the “Reset” packet from another playback device having smaller device ID, the playback device 111 is changed/switched to slave playback device. On the other hand, if the playback device 111 receives the “Reset” packet from another playback device having greater device ID, the playback device 111 will be changed/switched back to master playback device, and the current master playback device is changed/switched to slave playback device. When being changed/switched back to master playback device, the playback device 111 enters the preparing state MST1 or the playback state MST2. The decision making process as described above is the election mechanism. That is to say, the election mechanism is based on the device ID of each of the playback devices.

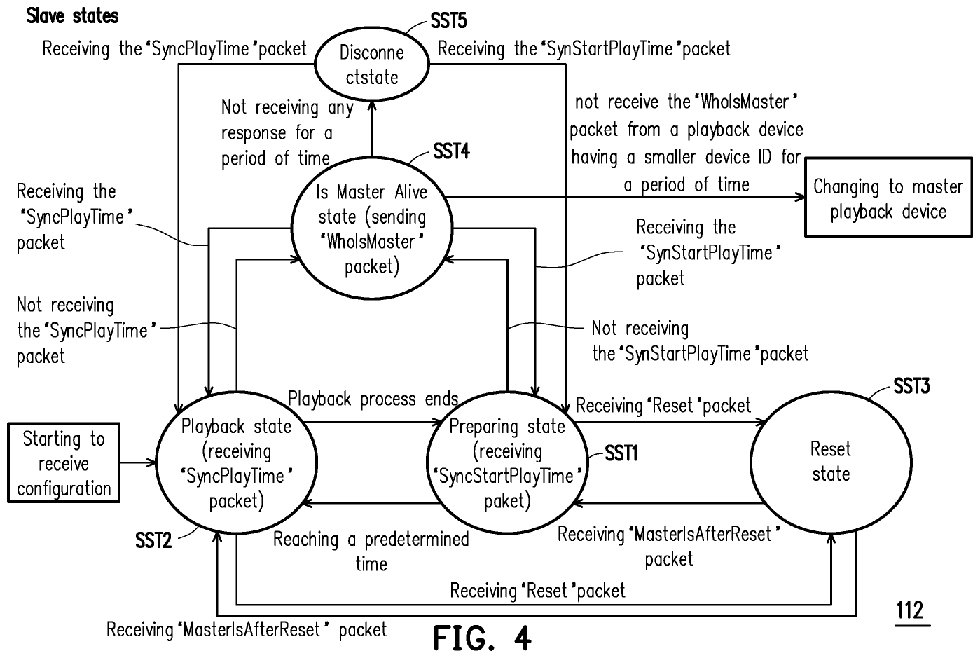

FIG. 4 is a schematic view indicating states of the slave playback device shown in FIG. 1. To be more specific, the states of the slave playback device 112 in the first group 110 are described in FIG. 4, the states of other slave playback devices 113 and 114 in the first group 110 are similar to the states of the slave playback device 112. Further, the states of other slave playback devices (such as the slave playback devices 122, 123, and 124) in other groups are similar to the states of the slave playback device 112 in the first group 110. In the present embodiment, after the playback device 112 in the first group 110 is designated as the slave playback device, the slave playback device 112 starts to receive configuration. At this time, it is confirmed that the setting file is obtained in the storage medium of the USB interface. In addition, when the predetermined time in the setting file is reached, the playback starts and the slave playback device 111 enters a playback state SST2. In the playback state SST2, the slave playback device 112 receives the “SyncPlayTime” packet sent by the master playback device 111 every second. Therefore, the slave playback device 112 is informed about the playback timepoint of the video is currently played in the master playback device 111. Since the playback timepoint of the video played in the master playback device 111 and the standard time information are all received by the slave playback device 112, the playback process of the master playback device 111 and the playback process of the slave playback device 112 are synchronized with each other.

Next, after the playback process of one video ends and the playback process of the next video is not required, the slave playback device 112 enters a preparing state SST1. In the preparing state SST1, the slave playback device 112 receives the “SynStartPlayTime” packet sent from the master playback device 111 every second so that the slave playback device 112 is informed about the predetermined time when the next playback process is scheduled. When the predetermined time is reached, the slave playback device 112 enters the playback state SST2 again, so that the playback process of the slave playback device 112 is synchronized with the playback process of the master playback device 111.

Further, when the slave playback device 112 does not receive the “SynStartPlayTime” packet in the preparing state SST1 or the “SyncPlayTime” packet in the playback state SST2 from the master playback device 111 in a period of time, which is called the period of time T0, the slave playback device 112 enters the Is Master Alive state SST4 and starts to send the “WhoIsMaster” packet to confirm whether the master playback device 111 is disconnected from the first local area network LAN1. After sending the “WhoIsMaster” packet, in case that the slave playback device 112 receives the “SynStartPlayTime” packet or the “SyncPlayTime” packet, the slave playback device 112 returns to the preparing state SST1 or the playback state SST2, respectively. On the other hand, after sending the “WhoIsMaster” packet, in case that the slave playback device 112 does not receive any response for a period of time, which is called the second period of time T1, the slave playback device 112 enter a disconnect state SST5. Further, in the disconnect state SST5, if the slave playback device 112 receives the “SynStartPlayTime” packet or the “SyncPlayTime” packet, the slave playback device 112 will return to the preparing state SST1 or the playback state SST2, respectively.

Additionally, in the Is Master Alive state SST4, if it is confirmed that the master playback device 111 has been disconnected, and the device ID of the slave playback device 112 is the smallest device ID among the slave playback devices, the slave playback device 112 will become a new master playback device. To be more specific, in the Is Master Alive state SST4, the slave playback device 112 does not receive the “WhoIsMaster” packet from a playback device having a smaller device ID for a period of time, which is called the second period of time T2, it means that the master playback device 111 has been disconnected and the slave playback device 112 has the smallest device ID. Consequently, the slave playback device 112 becomes the new master playback device. In the present embodiment, the slave playback device 112 has smallest device ID, so the slave playback device 112 broadcasts “WhoIsMaster” packet first and have a better change to be the new master playback device, but the disclosure is not limited thereto. In other embodiments, any slave playback device having smallest device ID has the first priority to broadcast “WhoIsMaster” packet so as to have a better change to be the new master playback device. In some other embodiments, the device ID of the new master playback device 112 may be changed to a negative value.

It should be noted here, the first period of time T0, the second period of time T1, and the second period of time T2 may be set by the user, and the second period of time T2 may be shorter than the second period of time T1. However, the disclosure is not limited thereto.

In the present embodiment, each of the playback devices 111 to 114 includes one election mechanism. Further, the election mechanism elects a new master playback device according to the device ID.

Further, as mentioned above, there is a situation that the master playback device 111 is disconnected from the first local area network LAN1 and the slave playback device 112 is selected to be the current master playback device in order to replace the master playback device 111. When the playback device 111 is connected to the first local area network LAN1 again, there are some cases as follows. In case that the playback device 111 is connected to the first local area network LAN1 again in the preparing state MST1 and receives the “SynStartPlayTime” packet sent by the slave playback device 112 in the first group 110, or in case that the playback device 111 is connected to the first local area network LAN1 again in the playback state MST2 and receives the “SyncPlayTime” packet sent by the slave playback device 112 in the first group 110, the playback device 111 will enter the reset state MST3 and will broadcast the “Reset” packet, so as to send the “Reset” packet to each of the slave playback devices 112, 113, and 114 in the first group 110. When receiving the “Reset” packet, the slave playback device 112 in the preparing state SST1 or the playback state SST2 enters a reset state SST3. After the master playback device is determined, the playback device 112 receives the MasterIsAfterReset” packet and returns to the preparing state SST1 or the playback state SST2.

In the present embodiment, the groups 110 and 120 may play different video files. However, each of the groups 110 and 120 play the same video file. As an example, in the group 110, the master playback device 111 and the slave playback devices 112, 113, and 114 together display and form one image or one frame of the video at a timepoint. To be more specific, the time difference between the playback timepoint of each of the slave playback devices and the playback timepoint of the master playback device is kept within a preset time T. For example, the preset time T may be 100 milliseconds (ms), but the disclosure is not limited thereto. Hence, in the first group 110, the time difference between the playback timepoint of each of the slave playback devices 112, 113, and 114 and the playback timepoint of the master playback device 111 is kept within 100 ms. Similarly, in the second group 120, the time difference between the playback timepoint of each of the slave playback devices 122, 123, and 124 and the playback timepoint of the master playback device 121 is kept within 100 ms.

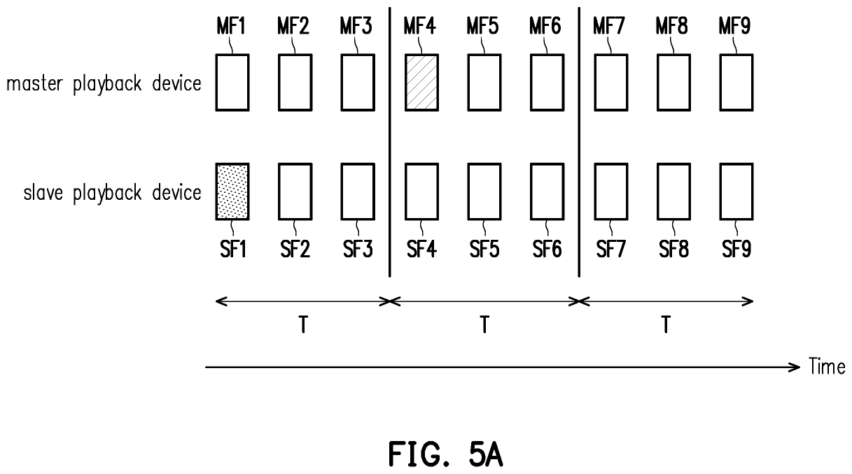

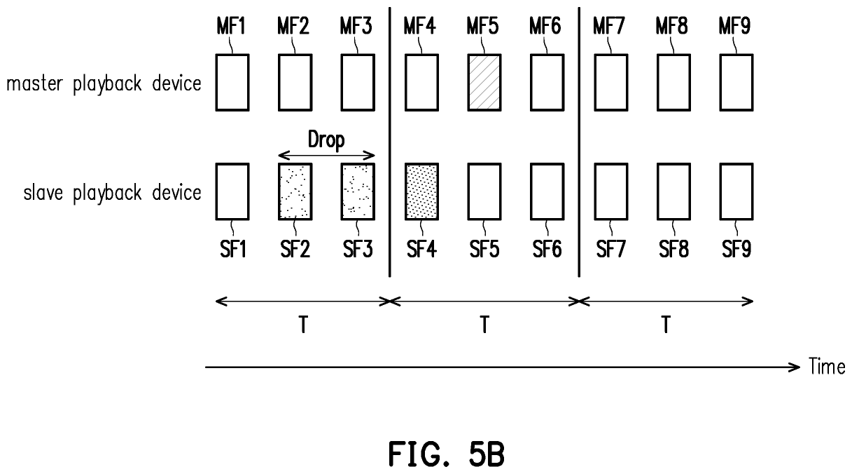

FIG. 5A is a schematic view showing difference in playback timepoint between a master playback device and a slave playback device. FIG. 5B is a schematic view of adjustment in playback timepoint of the slave playback device in FIG. 5A. In FIG. 5A and FIG. 5B, a plurality of frames MF1 to MF9 played by the master playback device are corresponding to a plurality of frames SF1 to SF9 played by the salve playback device, respectively. To be more specific, the frame MF1 and the frame SF1 belong to the same frame at a playback timepoint of the video played by one group of playback devices, the frame MF2 and the frame SF2 belong to the same frame at another playback timepoint of the video played by one group of playback devices, and so on. As shown in FIG. 5A, in the same group, the master playback device displays the frame MF4, but the slave playback device displays the frame SF1 which is not corresponding to the frame MF4. Further, the time difference between the frame SF4, which is corresponding to the frame MF4, and the frame SF1 is greater than the preset time T, which is 100 ms as an example. In other words, the master playback device plays faster than the slave playback device and the time difference between the playback timepoint of the master playback device and the playback timepoint of the slave playback device is greater than 100 ms. Under this circumstance, the slave playback device skips displaying the interval frames which are the frames SF2 and SF3 and displays the frame SF4. Therefore, as shown in FIG. 5B, the master playback device displays the frame MF5 and the slave playback device displays the frame SF4. At this time, the time difference between the frame SF4 and the frame SF5, which corresponding to the frame MF5, is smaller than 100 ms. In other words, the time difference between the playback timepoint of each of the slave playback devices and the playback timepoint of the master playback device is kept within 100 ms.

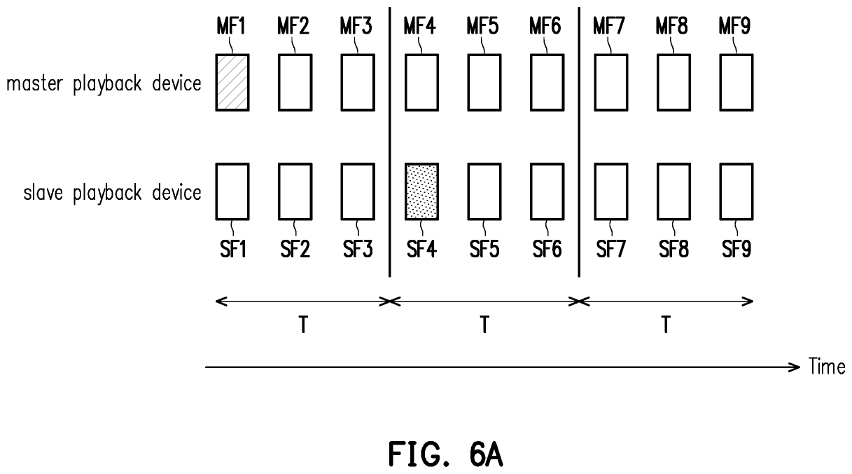

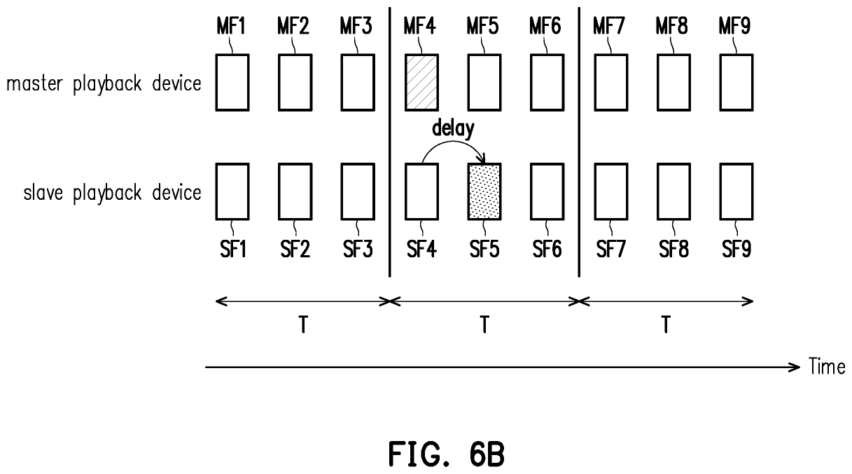

FIG. 6A is a schematic view showing difference in playback timepoint between a master playback device and a slave playback device. FIG. 6B is a schematic view of adjustment in playback timepoint of the slave playback device in FIG. 6A. As shown in FIG. 6A, in the same group, the master playback device displays the frame MF1, but the slave playback device displays the frame SF4 which is not corresponding to the frame MF1. Further, the time difference between the frame SF1, which is corresponding to the frame MF1, and the frame SF4 is greater than the predetermined time T, which is 100 ms as an example. In other words, the master playback device plays slower than the slave playback device and the time difference between the playback timepoint of the master playback device and the playback timepoint of the slave playback device is greater than 100 ms. Under this circumstance, the slave playback device delays the playback process and wait for the master playback device. Therefore, as shown in FIG. 6B, the slave playback device displays the frame SF5 and then delays the playback process until the master playback device displays the frame MF4. At this time, the time difference between the frame SF5 and the frame SF4, which corresponding to the frame MF4, is smaller than 100 ms. In other words, the time difference between the playback timepoint of each of the slave playback devices and the playback timepoint of the master playback device is kept to be within 100 ms. It should be noted here, the master playback device broadcasts the “SyncPlayTime” packet so as to send the current playback timepoint to each of the slave playback devices.

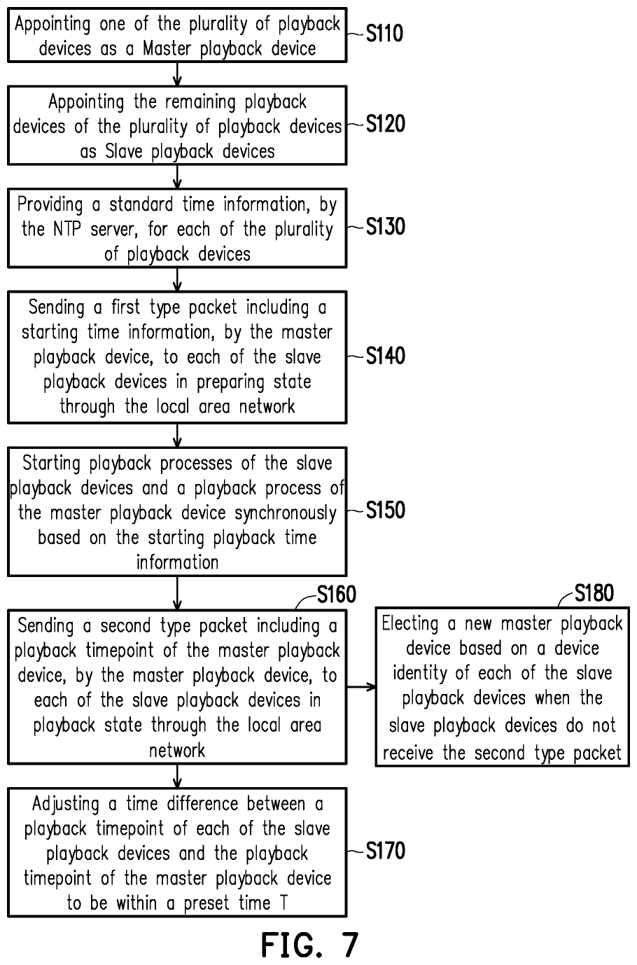

FIG. 7 is a flowchart showing a multi-screen synchronized playback method of a group shown in FIG. 1. As shown in FIG. 7, in the first group 110, the user appoints one of the playback devices as a master playback device in step S110. Next, in the step S120, the user appoints the remaining playback devices of the playback devices in the first group 110 as slave playback devices. To be more specific, by the method of assigning weight, the playback device 111 is designated as the master playback device, and the playback devices 112, 113, and 114 are designated as slave playback devices in the first group 110. In the step S130, the NTP server 140 provides a standard time information for each of the playback devices 111, 112, 113, and 114 in the first group 110.

Next, in the step S140, the master playback device 111 in preparing state sends the first type packet to each of the slave playback devices 112, 113, and 114 through the first local area network LAN1. Specifically, the first type packet includes a starting playback time information according to the standard time information provided by the NTP server 140. That is to say, the first type packet is the “SynStartPlayTime” packet as mentioned above. After the slave playback devices 112, 113, and 114 receive the first type packet from the master playback device 111 in preparing state, the playback processes of the slave playback devices 112, 113, and 114 and a playback process of the master playback device 111 are synchronously started based on the starting playback time information (step S150). Consequently, the first group 110 starts the playback process and the playback devices 111, 112, 113, and 114 starts to display the frames of the video. At this time, (step S160) the master playback device 111 in playback state sends the second type packet to each of the slave playback devices 112, 113, and 114 through the first local area network LAN1, wherein the second type packet includes a playback timepoint of the master playback device 111. That is to say, the second type packet is the “SyncPlayTime” packet as mentioned above.

During the playback process, the time difference between the playback timepoint of each of the slave playback devices 112, 113, and 114 and the playback timepoint of the master playback device 111 is adjusted to be within the preset time T (step S170). The preset time T may be 100 ms, but the disclosure is not limited thereto. Further, during the playback process, in the case that the master playback device 111 is disconnected from the first local area network LAN1, the slave playback devices 112, 113, and 114 do not receive the second type packet from the master playback device 111. At that time, one of the slave playback devices 112, 113, and 114 is elected to be a new master playback device (step S180). The one having the smallest device ID in the three slave playback devices 112, 113, and 114 enters the Is Master Alive state SST4 first, and then broadcasts the “WhoIsMaster” packet. To be more specific, the slave playback device 112 has a smaller device ID than the slave playback devices 113, and 114, so the slave playback device 112 enters the Is Master Alive state SST4 first, and then broadcasts the “WhoIsMaster” packet. If it is confirmed that the master playback device 111 has been disconnected, and the device ID of the slave playback device 112 is the smallest, the slave playback device 112 will become the new master playback device. In other words, the slave playback device with smaller device ID have a better chance to be the new master playback device.

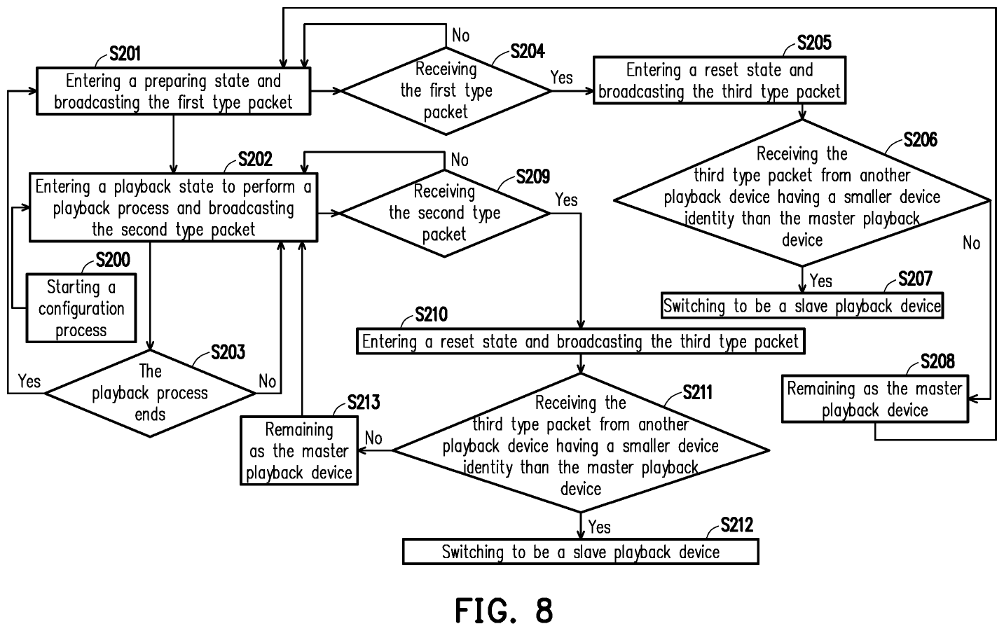

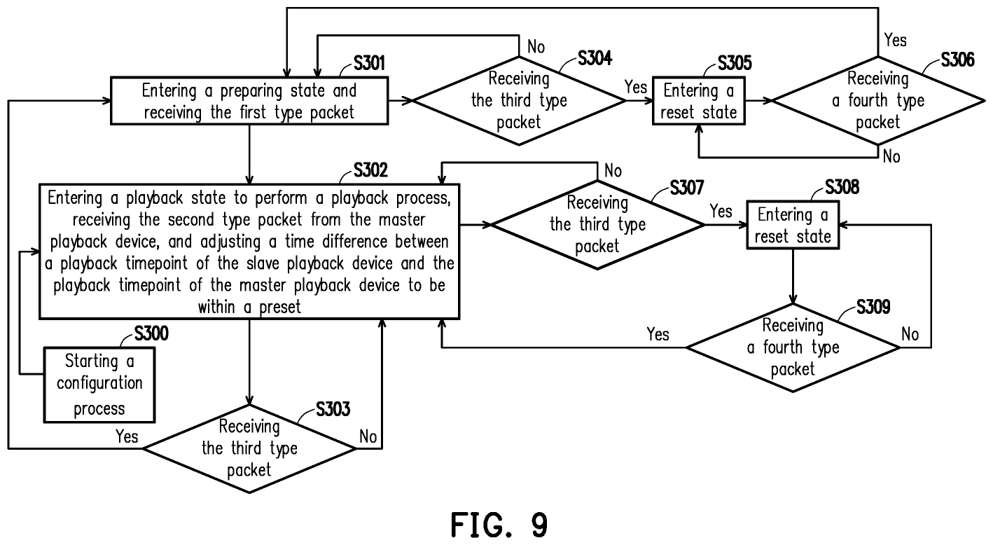

The above-mentioned description is for easier understanding the multi-screen synchronized playback method. Further, at the beginning of the multi-screen synchronized playback method, after receiving the configuration, the play back processes of the master playback device and slave playback devices are performed once before entering the step S140, which is shown in FIGS. 3-4 and will be shown in FIGS. 8 and 9 below.

The multi-screen synchronized playback method of the second group 120 is similar to the multi-screen synchronized playback method of the first group 110, thus it is not repeated.

FIG. 8 is a flow chart depicting a master playback process of the master playback device in FIG. 3. To be more specific, the master playback process of the master playback device 111 in the multi-screen synchronized playback system 100 is described as follows. After the playback device 111 in the first group 110 is designated as the master playback device, the master playback device 111 starts configuration process (Step S200).

In Step S201, the master playback device 111 enters the preparing state and broadcast the first type packet (the “SynStartPlayTime” packet) to the slave playback devices 112 to 114 in the preparing state. The first type packet includes the starting playback time information according to the standard time information provided by the NTP server.

After that, in Step S202, the master playback device 111 enters the playback state based on the starting playback time information to perform the playback process and broadcasts the second type packet (the “SyncPlayTime” packet) to the slave playback devices 112 to 114 while performing the playback process in the playback state. The second type packet includes the playback timepoint of the master playback device 111.

Next, the master playback device 111 returns to the preparing state after the playback process ends (Step 203). It should be noted here, at the beginning, after starting configuration process (Step S200), the master playback device 111 directly performs the Step S202.

Further, when the master playback device 111 receives the first type packet in the preparing state (Step 204) or when the master playback device 111 receives the second type packet in the playback state (Step 209), the master playback device 111 enters the reset state and broadcasts the third type packet (Steps 205 and 210), which is the “Reset” packet.

When the master playback device 111 receives the third type packet from another playback device (such as one of the playback devices 112 to 114) having a smaller device identity than the master playback device 111 (Steps 206 and 211), the master playback device 111 is switched to be a slave playback device (Steps 207 and 212).

When the master playback device 111 does not receive the third type packet from another playback device having a smaller device identity than the master playback device (Steps 206 and 211), the playback device 111 remains as the master playback device (Steps 208 and 213) and returns to the preparing state (Step S201) or the playback state (Step S202).

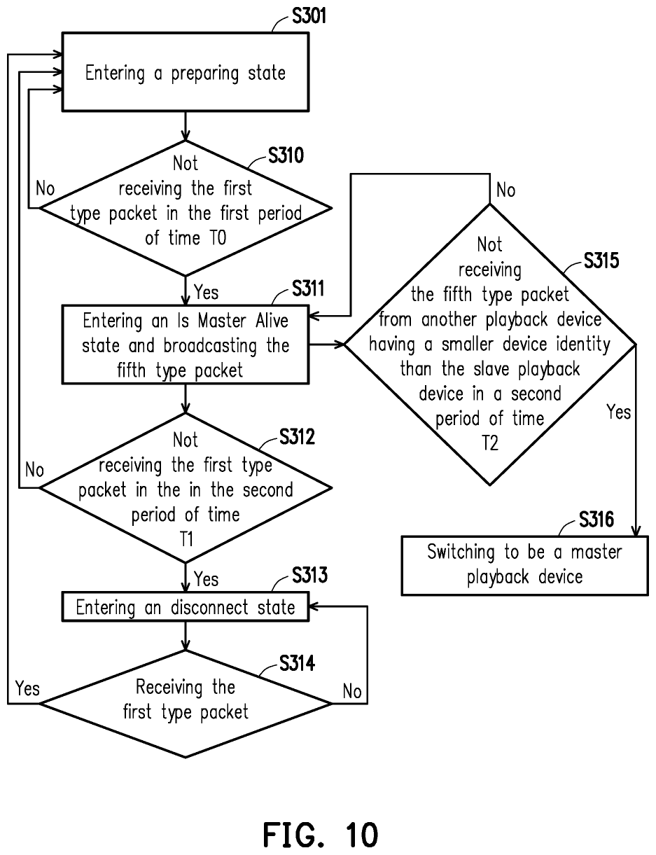

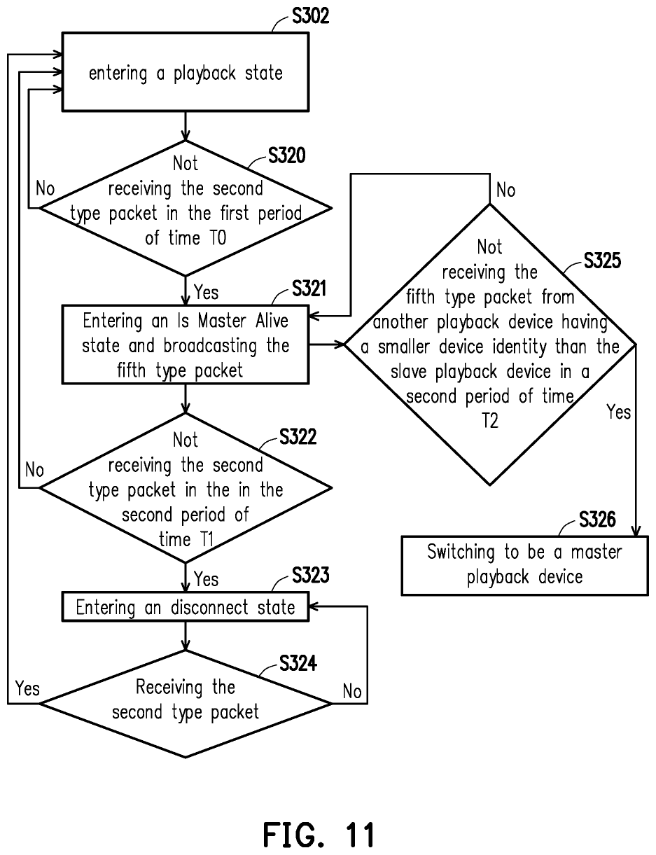

FIG. 9, FIG. 10, and FIG. 11 are flowcharts depicting a slave playback process of the slave playback device in FIG. 4. To be more specific, the slave playback process of the slave playback device 112 in the multi-screen synchronized playback system 100 is described as follows. As shown in FIG. 9, after the playback device 112 in the first group 110 is designated as the slave playback device, the slave playback device 112 starts configuration process (Step S300).

In Step S301, the slave playback device 112 enters the preparing state and receives the first type packet (the “SynStartPlayTime” packet) from the master playback device 111 in the preparing state. As mentioned above, the first type packet includes the starting playback time information according to the standard time information provided by the NTP server;

After that, in Step S302, the slave playback device 112 enters the playback state based on the starting playback time information to perform the playback process, and the slave playback device 112 receives the second type packet (the “SyncPlayTime” packet) from the master playback device 111 while performing the playback process in the playback state. As mentioned above, the second type packet includes the playback timepoint of the master playback device 111. In Step S302, the slave playback device 112 also adjusts the time difference between the playback timepoint of the slave playback device 112 and the playback timepoint of the master playback device 111 to be within the preset time T while performing the playback process in the playback state.

Next, the slave playback device 112 returns to the preparing state after the playback process ends (Step 303). It should be noted here, at the beginning, after starting configuration process (Step S300), the slave playback device 112 directly performs the Step S302.

Further, when the slave playback device 112 receives the third type packet (the “Reset” packet) in the preparing state (Step S304) or the playback state (Step S307), the slave playback device 112 enters the reset state (Steps S305 and S307).

When the slave playback device 112 receives the fourth type packet (Steps S306 and S309), which is the “MasterIsAfterReset” packet , the slave playback device 112 returns to the preparing state (Step S301) or the playback state (Step S302). The fourth type packet includes identity information of a current master playback device.

As shown in FIGS. 10-11, at the Step S301 or the Step S302, when, in the first period of time T0, the slave playback device 112 does not receive the first type packet in the preparing state (Step S310), or when, in the first period of time T0, the slave playback device 112 does not receive the second type packet in the playback state (Step S320), the slave playback device 112 enters the Is Master Alive state and broadcasts the fifth type packet (Steps S311 and S321), which is the “WhoIsMaster” packet.

When the slave playback device 112 receives the first type packet (Step S312), the slave playback device 112 returns to the preparing state (Step S301). When the slave playback device 112 receives the second type packet (Step S322), the slave playback device 112 returns to the playback state (Step S302).

When the slave playback device 112 does not receive the first type packet in the second period of time T1 (Step S312) and the slave playback device 112 does not receive the second type packet in the second period of time T1 (Step S322), the slave playback device 112 enters the disconnect state from the Is Master Alive state (Steps S313 and S323). In the disconnect state, when the slave playback device 112 receives the first type packet (Step S314), the slave playback device 112 returns to the preparing state (Step S301) from the disconnect state. Similarly, In the disconnect state, when the slave playback device 112 receives the second type packet (Step S324), the slave playback device 112 returns to the playback state (Step S302) from the disconnect state.

Further, in the Is Master Alive state, when the slave playback device 112 does not receive the fifth type packet from another playback device having a smaller device identity than the slave playback device 112 in the second period of time T2 (Steps S315 and S325), the slave playback device 112 is switched to be a master playback device (Steps S316 and S326).

In summary, in the disclosure, the playback devices in the same group can achieve the function of automatically controlling the playback progress via network protocol, in order to achieve synchronous playback without any additional hardware device required. The playback devices indicated as in the same group join the same LAN via Ethernet or Wireless Network. By assigning weight method, the user can appoint one of the playback devices in one group as master playback device, and the other playback devices in the same group are designated as slave playback devices. The master playback device and the slave playback devices obtain an accurate time for synchronization through network and designated/specified NTP server. The master playback device, viva a specific/designated network protocol, sends the time information, such as starting playback time information and playback timepoint, for playback in order to control the playback process of the slave playback devices, thereby achieving playback synchronization.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A multi-screen synchronized playback system, comprising:
a group, comprising a plurality of playback devices connected to a local area network (LAN), wherein one of the plurality of playback devices is designated as a master playback device, the remaining playback devices of the plurality of playback devices are designated as slave playback devices; and
a network time protocol (NTP) server, connected to the LAN and providing a standard time information for each of the plurality of playback devices, wherein, in preparing state, the master playback device sends a first type packet to each of the slave playback devices through the local area network, and the first type packet comprises a starting playback time information according to the standard time information provided by the NTP server.

2. The multi-screen synchronized playback system as recited in claim 1, wherein the slave playback devices receive the first type packet from the master playback device in preparing state, and playback processes of the slave playback devices and a playback process of the master playback device are synchronously started based on the starting playback time information.

3. The multi-screen synchronized playback system as recited in claim 1, wherein, in playback state, the master playback device sends a second type packet to each of the slave playback devices through the local area network, and the second type packet comprises a playback timepoint of the master playback device.

4. The multi-screen synchronized playback system as recited in claim 3, wherein a time difference between a playback timepoint of each of the slave playback devices and the playback timepoint of the master playback device is kept within a preset time.

5. The multi-screen synchronized playback system as recited in claim 3, wherein an election mechanism is used to elect a new master playback device based on a device identity of each of the slave playback devices when the slave playback devices do not receive the second type packet.

6. The multi-screen synchronized playback system as recited in claim 3, wherein each of the first type packet and the second type packet is a string datatype comprising a packet type, a group identity, a device identity, and a data.

7. A multi-screen synchronized playback method of a multi-screen synchronized playback system having a group comprising a plurality of playback devices connected to a local area network (LAN) and a network time protocol (NTP) server connected to the LAN, comprising:
appointing one of the plurality of playback devices as a master playback device;
appointing the remaining playback devices of the plurality of playback devices as slave playback devices;
providing a standard time information, by the NTP server, for each of the plurality of playback devices;
sending a first type packet, by the master playback device, to each of the slave playback devices in preparing state through the local area network, wherein the first type packet comprises a starting playback time information according to the standard time information provided by the NTP server; and
starting playback processes of the slave playback devices and a playback process of the master playback device synchronously based on the starting playback time information after the slave playback devices receive the first type packet from the master playback device in preparing state.

8. The multi-screen synchronized playback method as recited in claim 7, further comprising:
sending a second type packet, by the master playback device, to each of the slave playback devices in playback state through the local area network, wherein the second type packet comprises a playback timepoint of the master playback device.

9. The multi-screen synchronized playback method as recited in claim 8, further comprising:
adjusting a time difference between a playback timepoint of each of the slave playback devices and the playback timepoint of the master playback device to be within a preset time.

10. The multi-screen synchronized playback method as recited in claim 8, further comprising:
electing a new master playback device based on a device identity of each of the slave playback devices when the slave playback devices do not receive the second type packet.

11. A master playback process of a master playback device in a multi-screen synchronized playback system having a group comprising the master playback device and a plurality of slave playback devices, the master playback device and the slave playback devices being connected to a local area network (LAN), and a network time protocol (NTP) server being connected to the LAN, comprising:
entering a preparing state and broadcasting a first type packet to the slave playback devices in the preparing state, wherein the first type packet comprises a starting playback time information according to a standard time information provided by the NTP server;
entering a playback state based on the starting playback time information to perform a playback process and broadcasting a second type packet to the slave playback devices while performing the playback process in the playback state, wherein the second type packet comprises a playback timepoint of the master playback device; and
returning to the preparing state after the playback process ends.

12. The master playback process of the master playback device in a multi-screen synchronized playback system as recited in the claim 11, further comprising:
entering a reset state and broadcasting a third type packet when receiving the first type packet in the preparing state or when receiving the second type packet in the playback state; and
switching to be a slave playback device when receiving the third type packet from another playback device having a smaller device identity than the master playback device.

13. The master playback process of the master playback device in a multi-screen synchronized playback system as recited in the claim 12, further comprising:
remaining as the master playback device and returning to the preparing state or the playback state when not receiving the third type packet from another playback device having a smaller device identity than the master playback device.

14. The master playback process in a multi-screen synchronized playback system as recited in the claim 11, further comprising:
starting a configuration process after being designated as the master playback device.

15. A slave playback process of a slave playback device in a multi-screen synchronized playback system having a group comprising a master playback device and a plurality of the slave playback devices, the master playback device and the slave playback devices being connected to a local area network (LAN), and a network time protocol (NTP) server being connected to the LAN, comprising:
entering a preparing state and receiving a first type packet from the master playback device in the preparing state, wherein the first type packet comprises a starting playback time information according to a standard time information provided by the NTP server;
entering a playback state based on the starting playback time information to perform a playback process, receiving a second type packet from the master playback device while performing the playback process in the playback state, wherein the second type packet comprises a playback timepoint of the master playback device, and adjusting a time difference between a playback timepoint of the slave playback device and the playback timepoint of the master playback device to be within a preset time while performing the playback process in the playback state; and
returning to the preparing state after the playback process ends.

16. The slave playback process of the slave playback device in a multi-screen synchronized playback system as recited in claim 15, further comprising:
entering a reset state when receiving a third type packet in the preparing state or the playback state; and
returning to the preparing state or the playback state when receiving a fourth type packet, wherein the fourth type packet comprises identity information of a current master playback device.

17. The slave playback process of the slave playback device in a multi-screen synchronized playback system as recited in claim 15, further comprising:
entering an Is Master Alive state when, in a first period of time, not receiving the first type packet in the preparing state or when, in a first period of time, not receiving the second type packet in the playback state and broadcasting a fifth type packet; and
returning to the preparing state when receiving the first type packet or returning to the playback state when receiving the second type packet.

18. The slave playback process of the slave playback device in a multi-screen synchronized playback system as recited in claim 17, further comprising:
entering a disconnect state from the Is Master Alive state when not receiving the first type packet and not receiving the second type packet in a second period of time.

19. The slave playback process of the slave playback device in a multi-screen synchronized playback system as recited in claim 18, further comprising:
returning to the preparing state from the disconnect state when receiving the first type packet or returning to the playback state from the disconnect state when receiving the second type packet.

20. The slave playback process of the slave playback device in a multi-screen synchronized playback system as recited in claim 17, further comprising:
switching to be a master playback device when, in a second period of time and in the Is Master Alive state, not receiving the fifth type packet from another playback device having a smaller device identity than the slave playback device.

21. The slave playback process of the slave playback device in a multi-screen synchronized playback system as recited in claim 15, further comprising:
starting a configuration process after being designated as the slave playback device.
